(19) United States
(12) Patent Application Publication
(10) Pub. No.: US 2024/0086378 A1
(43) Pub. Date: Mar. 14, 2024

(54) SERVERLESS SCHEMA PROPAGATION

(71) Applicant: International Business Machines Corporation, Armonk, NY (US)

(72) Inventors: Jesus Manuel Olivera Olivera, New York, NY (US); David Patrick Cavanaugh, Enfield, NH (US)

(73) Assignee: International Business Machines Corporation, Armonk, NY (US)

(21) Appl. No.: 17/942,746

(22) Filed: Sep. 12, 2022

(51) Int. Cl. G06F 16/21; G06F 16/23; G06F 16/28

(52) U.S. Cl. CPC G06F 16/213; G06F 16/2365; G06F 16/284

(57) ABSTRACT

A source schema is extracted from a source database and a target schema is extracted from a target database. By comparing the source schema with the target schema, a mismatch between the source schema and the target schema is identified. Data from the source database is stored in the target database according to the target schema and the mismatch.

### BACKGROUND

The present invention relates generally to a method, system, and computer program product for database management. More particularly, the present invention relates to a method, system, and computer program product for serverless schema propagation.

A database schema describes the structure of a database, defining the name, type, format, and meaning of the data stored in a database. For example, the schema of a relational database defines the tables, fields, relationships, views, indexes, packages, procedures, functions, queues, triggers, types, sequences, materialized views, synonyms, database links, directories, and other elements of the relational database. A table is a collection of related data. A row in a table represents a single, implicitly structured data item, and a column in a table specifies a set of data values of a particular attribute. Thus, a row-column intersection represents a particular value for a particular attribute. For example, in a table that represents companies, each row might represent a single company. Columns might represent attributes such company name, company street address, and whether the company is publicly held. Thus, cells where rows intersect the “company name” column would each represent particular company names such as Corporation A and Business B. A database field includes a format for the field. For example, format information for a field holding the number of people living in a household might be an integer, while format information for a date field might be mmddyyyy (two digits denoting a month, two digits denoting a day of the month, and four digits denoting a year) or ddmmyyyy (two digits denoting a day of the month, two digits denoting a month, and four digits denoting a year). A database schema is also called metadata of a database.

Schema propagation refers to moving a database schema, and the data to which the schema refers, from a source database to another, target database. For example, data from multiple databases, with different schemas, might need to be consolidated into one database.

The term serverless refers to performing schema propagation without executing a process on the same system as the source database. Instead, data is exported from the source database and processed on another system. Serverless schema propagation is desirable because it is flexible, allowing the propagation process to execute on any suitable system. As well, an entity performing schema propagation may not be the same entity as is responsible for the source database, and thus avoiding the consumption of additional data processing resources on another entity's system is desirable.

### SUMMARY

The illustrative embodiments provide a method, system, and computer program product. An embodiment includes a method that extracts a source schema from a source database and a target schema from a target database. An embodiment identifies, by comparing the source schema with the target schema, a mismatch between the source schema and the target schema. An embodiment stores, in the target database according to the target schema and the mismatch, data from the source database.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts an example diagram of a data processing environments in which illustrative embodiments may be implemented;

FIG. 2 depicts a block diagram of an example configuration for serverless schema propagation in accordance with an illustrative embodiment;

FIG. 3 depicts an example of serverless schema propagation in accordance with an illustrative embodiment;

FIG. 4 depicts examples of attribute comparison results and corresponding target database updates used in serverless schema propagation in accordance with an illustrative embodiment;

FIG. 5 depicts a flowchart of an example process for serverless schema propagation in accordance with an illustrative embodiment;

FIG. 6 depicts a flowchart of an example process for serverless schema propagation in accordance with an illustrative embodiment.

### DETAILED DESCRIPTION

The illustrative embodiments recognize that automated tools are presently available to configure and orchestrate ETL (extract, transform, load) jobs to perform data validation and data replication. These jobs include schema checks, which review data types, data length, column names, indexes, and other metadata for consistency between source and target databases. However, using these tools requires that a human user manually generate a mapping document specifying source and target table definitions and conversions between them. As well, a human user must define steps in the schema checking and an execution sequence for those steps. However, a human user with sufficient knowledge of the data may not be knowledgeable in database propagation, and a human user with knowledge in database propagation may not be sufficiently familiar with a particular database to generate a mapping document that understands attribute synonyms, particularly in different areas of knowledge. Many tools also have extensive configuration options, but human users find that there are too many choices and simply rely on possibly suboptimal defaults. In addition, existing tool implementations are usually designed to store metadata models on the same system as the source database. Once schema checking has been defined, other existing automated tools must be integrated to complete a data validation pipeline between databases and replicate any updates from one schema to another. Currently available implementations typically create and manage snapshots of schemas, using a server to tracks updates and another server to publish those changes from source to target.

Thus, while actually moving data can be automated, the illustrative embodiments recognize that defining conversions between source and target schemas remains an error-prone process that must be managed by humans with sufficient knowledge of the data stored in the databases to recognize when a new field is present in a source database and define appropriate conversions from one database to another. For example, a source database recording patient health data for pharmaceutical trials might include a field for COVID-19 vaccination status, while a target database defined prior to the COVID-19 pandemic might not include such a field. As another example, a source database holding office building details might include an attribute labelled “number of floors”, while a target database holding office building details might include an attribute labelled “number of levels” instead, and a human expert familiar with office building data would have to recognize that the two attributes are equivalents and should be merged under one attribute. As a third example, date formats often differ from one country to another, and a source database defined in one country might require date format conversion when being propagated to a target database defined in another country.

Thus, the illustrative embodiments recognize that there is an unmet need for schema propagation that, as part of an automated end-to-end data migration process, implements conversions between source and target schemas, including recognizing new fields in a source schema and when different attributes are actually synonyms, without requiring human expert knowledge of the data stored in the databases. There is also a need to learn from any user input to improve understanding of when different attributes are actually synonyms. There is also an unmet need to perform the automated end-to-end data migration process in a serverless manner, thus increasing flexibility in using computing resources.

The illustrative embodiments recognize that the presently available tools or solutions do not address these needs or provide adequate solutions for these needs. The illustrative embodiments used to describe the invention generally address and solve the above-described problems and other problems related to serverless schema propagation.

An embodiment can be implemented as a software application. The application implementing an embodiment can be configured as a modification of an existing database management system or database propagation system, as a separate application that operates in conjunction with an existing database management system or database propagation system, a standalone application, or some combination thereof.

Particularly, some illustrative embodiments provide a method that extracts a source schema from a source database and a target schema from a target database, identifies, by comparing the source schema with the target schema, a mismatch between the source schema and the target schema, and stores, in the target database according to the target schema and the mismatch, data from the source database.

One embodiment begins operation when triggered by a user. Another embodiment begins operation when triggered by an event, on a predetermined schedule, or by another application via an application programming interface. An embodiment is also scalable, allowing multiple instances of an embodiment or multiple, different, configurations of an embodiment to operate on the same or different databases simultaneously.

An embodiment receives authentication parameters for both a source and a target database. Some non-limiting examples of authentication parameters are the source database host name, source database name, source database username, source database password, source database port (used to connect to the source database for data transfer), target database host name, target database name, target database username, target database password, and target database port.

An embodiment also receives data of one or more immutable objects. An immutable object is an object in a database which is not to be changed, for example a data attribute or format. For example, an immutable object might be used to indicate that a date format is not to be changed from the format used in a source database.

An embodiment uses the authentication parameters to establish authenticated connections to both a source and a target database. If a source or a target database does not require authentication to connect to the database, an embodiment simply establishes a connection to the database. As long as the source and target databases are accessible to an embodiment via a communications network, an embodiment need not execute on the same system as either the source or target database. To communicate with a database, one embodiment uses Structured Query Language (SQL) statements. SQL is a presently available standard language for storing, manipulating and retrieving data in databases. However, the use of SQL is not required, and using another database query language to communicate with a database is also contemplated within the scope of the illustrative embodiments.

An embodiment extracts a source schema from a source database and a target schema from a target database. Techniques for extracting a schema from a database, using SQL statements or another database query language, are presently available. Another embodiment does not extract an entire schema, but instead extracts attributes and format data for the attributes from the schema. One embodiment stores attributes from the source schema, as well as format data for the attributes, in a source attribute list, and stores attributes from the target schema, as well as format data for the attributes, in a target attribute list. Another embodiment stores additional data from the source and target schemas in corresponding attribute lists. Some non-limiting examples of additional schema data are data of relationships between database tables, such as primary keys, foreign keys, references, and the like.

An embodiment identifies, by comparing the source schema with the target schema, a mismatch between the source and target schemas. In particular, one embodiment selects a source attribute from the source attribute list and compares the source attribute to every attribute in the target attribute list.

To compare attributes, one embodiment uses a presently available character string comparison tool to compare the characters in a source attribute with the characters in a target attribute. For example, the source attribute might be “date”, and the target attribute might also be “date”. Thus, a character string comparison tool will indicate that the two strings match each other. As another example, the source attribute might be “date”, and the target attribute might be “floor”, and thus a character string comparison tool will indicate that the two strings do not match each other. To compare attributes, another embodiment preprocesses attributes, then uses a presently available character string comparison tool to compare the characters in a preprocessed source attribute with the characters in a preprocessed target attribute. One embodiment preprocesses attributes by standardizing attributes to either upper or lower case. Another embodiment preprocesses attributes by eliminating one or more of underscores, spaces, and other commonly used word delimiters appropriate to a particular human language used in a database. Another embodiment preprocesses attributes using a different attribute preprocessing rule. Preprocessing attributes eliminates trivial differences between attributes, for example the difference between “date” and “Date”.

However, comparing attributes using string comparison misses attributes that are synonyms of each other. For example, if the source database uses “floors” as an attribute and the target database uses “levels” as an attribute instead, source data with the “floors” attribute should be stored in the target database using the “levels” attribute. However, if the synonyms are not recognized and data from the source database is propagated to the target database, the target database will now have two attributes (“floors” and “levels”), with some rows using one attribute and other rows using the other. This could introduce errors into the results of later database queries. Thus, to compare attributes, one embodiment uses a trained synonym model to compare a source attribute with a target attribute. One synonym model implementation uses a set of rules indicating amounts of similarity of pairs of words. Another synonym model implementation converts attributes to corresponding numerical representations using an encoding model, then compares the two numerical representations. The encoding model is trained to generate numerical representations that are similar to each other for attributes that are correspondingly similar. Thus, the closer the numerical representations are to each other, the greater the amount of similarity between attributes represented by the numerical representations. In one embodiment, each numerical representation is a multidimensional vector with each component in a range between zero and 1, and the embodiment uses cosine similarity to determine an angle between two vectors.

If an embodiment determines that a source attribute has above a threshold amount of similarity to a target attribute, the embodiment compares formats of the two attributes. If the formats are not identical, a format change will be needed when data with the source attribute is migrated to the target database. Thus, an embodiment adds a format conversion, when moving data from the source to the target attribute, to a database update list. The database update list holds updates to data from the source database to be implemented when data from the source database is propagated to the target database. If, however, the formats are identical, a format change will not be needed when data with the source attribute is migrated to the target database. Thus, an embodiment determines whether or not the source and target attributes are identical to each other. If the source and target attributes are not identical to each other, an attribute change will be needed when data with the source attribute is migrated to the target database. For example, if attributes “floors” and “levels” have above a threshold similarity to each other but are not identical, source data with the attribute “floors” would need to be stored in the target database using the “levels” attribute instead. Thus, an embodiment adds an attribute conversion, when moving data from the source to the target attribute, to the database update list.

If an embodiment determines that a source attribute has below a threshold amount of similarity to any target attribute, the source attribute is not present in the target schema, and needs to be added. Thus, an embodiment adds the source attribute to the target schema. Another embodiment does not add the source attribute to the target schema during attribute comparison, but instead adds the source attribute to a schema update list. The schema update list holds updates to the target schema to be implemented when data from the source database is propagated to the target database.

An embodiment selects another source attribute from the source attribute list and repeats the comparison process. One embodiment repeats the comparison process until every source attribute in the source attribute list has been compared in a manner described herein.

Another embodiment implements a comparison process with two thresholds, one above the other. If an embodiment determines that a source attribute has an amount similarity to a target attribute that is above the upper threshold, the embodiment compares formats of the two attributes. If the formats are not identical, an embodiment adds a format conversion, when moving data from the source to the target attribute, to the database update list. If, however, the formats are identical, an embodiment determines whether or not the source and target attributes are identical to each other. If the source and target attributes are not identical to each other, an attribute change will be needed, and an embodiment adds an attribute conversion, when moving data from the source to the target attribute, to the database update list.

If an embodiment determines that a source attribute has an amount of similarity below the lower threshold amount of similarity to any target attribute, the source attribute is not present in the target schema, and needs to be added. Thus, an embodiment adds the source attribute to the target schema. Another embodiment does not add the source attribute to the target schema during attribute comparison, but instead adds the source attribute to the schema update list.

If, however, an embodiment determines that a source attribute has an amount of similarity between the upper threshold and the lower threshold amount of similarity to a target attribute, the embodiment asks a user to confirm whether the attributes should be treated as synonyms or not. If the user confirms that the attributes should be treated as synonyms, an embodiment uses this data to update the synonym model. Updating the synonym model trains the synonym model to include a synonym relationship between the source attribute and the target attribute.

One embodiment uses different synonym models to determine synonyms in different areas of knowledge. For example, one synonym model might be used when processing databases storing pharmaceutical data, while another synonym model might be used when processing databases storing office building data. Implementing different synonym models for different areas of knowledge permits a subject matter expert to train a synonym model in his or her own area of expertise, and allows for adapting an embodiment to a different area of knowledge simply by changing a synonym to one trained on the new area of knowledge.

One embodiment obtains approval from a user before performing a target schema update or implementing any format or attribute conversions in the database update list. Another embodiment determines if there are any immutable objects in the database update list, and if so obtains approval from a user to implement the updates using a new attribute (which is added to the database update list). One embodiment records any target schema updates and format or attribute conversions. Recording the changes enables reversing any changes if desired. Recording the changes also improves auditing and reporting capabilities in schema versioning, as well as implementing an enforceable standard for schema management.

An embodiment using a schema update list updates the target schema according to the schema update list. An embodiment stores data from the source database in the target database, implementing any format or attribute conversions in the database update list that are also not in an immutable objects list during data storage. To obtain data from the source database and update the target schema and the target database, one embodiment uses SQL statements. Another embodiment uses statements in another database query language.

The manner of serverless schema propagation described herein is unavailable in the presently available methods in the technological field of endeavor pertaining to database management. A method of an embodiment described herein, when implemented to execute on a device or data processing system, comprises substantial advancement of the functionality of that device or data processing system in extracting a source schema from a source database and a target schema from a target database, identifying, by comparing the source schema with the target schema, a mismatch between the source schema and the target schema, and storing, in the target database according to the target schema and the mismatch, data from the source database.

The illustrative embodiments are described with respect to certain types of databases, schemas, attributes, formats, queries, database query languages, authentications, thresholds, adjustments, sensors, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

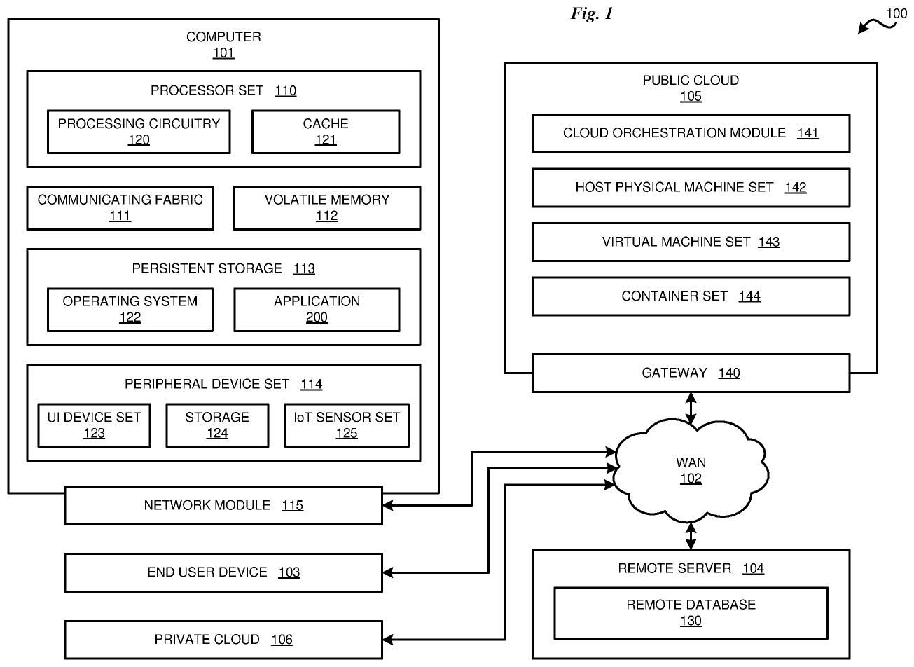

With reference to the figures and in particular with reference to FIG. 1, this figure is an example diagram of a data processing environments in which illustrative embodiments may be implemented. FIG. 1 is only an example and are not intended to assert or imply any limitation with regard to the environments in which different embodiments may be implemented. A particular implementation may make many modifications to the depicted environments based on the following description. FIG. 1 depicts a block diagram of a network of data processing systems in which illustrative embodiments may be implemented. Computing environment 100 contains an example of an environment for the execution of at least some of the computer code involved in performing the inventive methods, such as application 200. Application 200 implements a serverless schema propagation embodiment described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Application 200 executes in any of computer 101, end user device 103, remote server 104, or a computer in public cloud 105 or private cloud 106 unless expressly disambiguated. In addition, application 200 communicates with a source database and a target database stored in any of computer 101, end user device 103, remote server 104, or a computer in public cloud 105 or private cloud 106, or in another system. Application 200 need not execute in the same system as either a source or target database.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processor set 110 may contain one or more processors and may be implemented using one or more heterogeneous processor systems. A processor in processor set 110 may be a single- or multi-core processor or a graphics processor. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Operating system 122 runs on computer 101. Operating system 122 coordinates and provides control of various components within computer 101. Instructions for operating system 122 are located on storage devices, such as persistent storage 113, and may be loaded into at least one of one or more memories, such as volatile memory 112, for execution by processor set 110.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods of application 200 may be stored in persistent storage 113 and may be loaded into at least one of one or more memories, such as volatile memory 112, for execution by processor set 110. The processes of the illustrative embodiments may be performed by processor set 110 using computer implemented instructions, which may be located in a memory, such as, for example, volatile memory 112, persistent storage 113, or in one or more peripheral devices in peripheral device set 114. Furthermore, in one case, application 200 may be downloaded over WAN 102 from remote server 104, where similar code is stored on a storage device. In another case, application 200 may be downloaded over WAN 102 to remote server 104, where downloaded code is stored on a storage device.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in application 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, user interface (UI) device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. Internet of Things (IoT) sensor set 125 is made up of sensors that can be used in IoT applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

Wide area network (WAN) 102 is any WAN (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

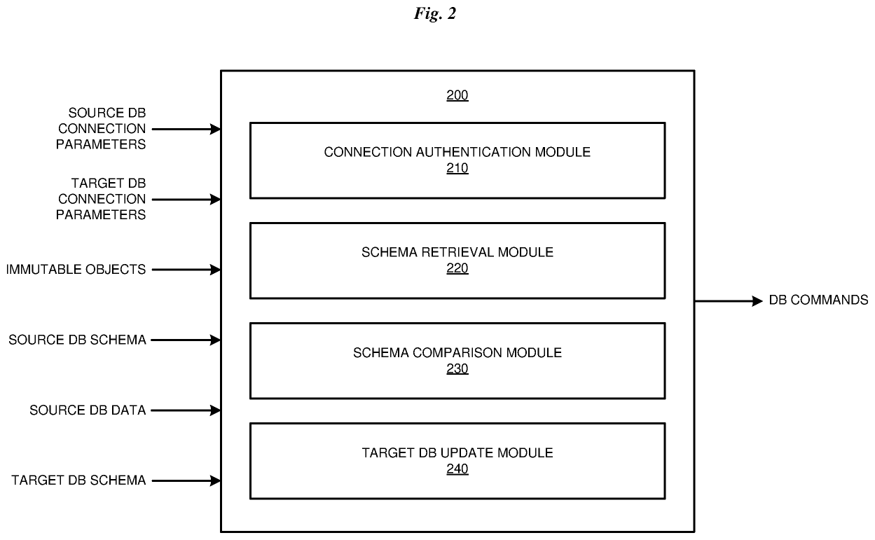

With reference to FIG. 2, this figure depicts a block diagram of an example configuration for serverless schema propagation in accordance with an illustrative embodiment. Application 200 is the same as application 200 in FIG. 1. Note that as used in FIGS. 2-6, DB is an abbreviation for database.

One implementation of application 200 begins operation when triggered by a user. Another implementation of application 200 begins operation when triggered by an event, on a predetermined schedule, or by another application via an application programming interface. Application 200 is also scalable, allowing multiple instances of application 200 or multiple, different, configurations of application 200 to operate on the same or different databases simultaneously.

Application 200 receives authentication parameters for both a source and a target database. Application 200 also receives data of one or more immutable objects.

Connection authentication module 210 uses the authentication parameters to establish authenticated connections to both a source and a target database. If a source or a target database does not require authentication to connect to the database, module 210 simply establishes a connection to the database. As long as the source and target databases are accessible to an embodiment via a communications network, application 200 need not execute on the same system as either the source or target database. To communicate with a database, one implementation of application 200 uses SQL statements. However, the use of SQL is not required, and using another database query language to communicate with a database is also possible.

Schema retrieval module 220 uses SQL statements or another database query language to extract a source schema from a source database and a target schema from a target database. Another implementation of module 220 does not extract an entire schema, but instead extracts attributes and format data for the attributes from the schema. One implementation of module 220 stores attributes from the source schema, as well as format data for the attributes, in a source attribute list, and stores attributes from the target schema, as well as format data for the attributes, in a target attribute list. Another implementation of module 220 stores additional data from the source and target schemas in corresponding attribute lists.

Schema comparison module 230 identifies, by comparing the source schema with the target schema, a mismatch between the source and target schemas. In particular, one implementation of module 230 selects a source attribute from the source attribute list and compares the source attribute to every attribute in the target attribute list.

To compare attributes, one implementation of module 230 uses a presently available character string comparison tool to compare the characters in a source attribute with the characters in a target attribute. To compare attributes, another implementation of module 230 preprocesses attributes, then uses a presently available character string comparison tool to compare the characters in a preprocessed source attribute with the characters in a preprocessed target attribute. One implementation of module 230 preprocesses attributes by standardizing attributes to either upper or lower case. Another implementation of module 230 preprocesses attributes by eliminating one or more of underscores, spaces, and other commonly used word delimiters appropriate to a particular human language used in a database. Another implementation of module 230 preprocesses attributes using a different attribute preprocessing rule.

To compare attributes, one implementation of module 230 uses a trained synonym model to compare a source attribute with a target attribute. One synonym model implementation uses a set of rules indicating amounts of similarity of pairs of words. Another synonym model implementation converts attributes to corresponding numerical representations using an encoding model, then compares the two numerical representations. The encoding model is trained to generate numerical representations that are similar to each other for attributes that are correspondingly similar. Thus, the closer the numerical representations are to each other, the greater the amount of similarity between attributes represented by the numerical representations. In one implementation of module 230, each numerical representation is a multidimensional vector with each component in a range between zero and 1, and the implementation uses cosine similarity to determine an angle between two vectors.

If module 230 determines that a source attribute has above a threshold amount of similarity to a target attribute, module 230 compares formats of the two attributes. If the formats are not identical, a format change will be needed when data with the source attribute is migrated to the target database. Thus, module 230 adds a format conversion, when moving data from the source to the target attribute, to a database update list. The database update list holds updates to data from the source database to be implemented when data from the source database is propagated to the target database. If, however, the formats are identical, a format change will not be needed when data with the source attribute is migrated to the target database. Thus, module 230 determines whether or not the source and target attributes are identical to each other. If the source and target attributes are not identical to each other, an attribute change will be needed when data with the source attribute is migrated to the target database. For example, if attributes “floors” and “levels” have above a threshold similarity to each other but are not identical, source data with the attribute “floors” would need to be stored in the target database using the “levels” attribute instead. Thus, module 230 adds an attribute conversion, when moving data from the source to the target attribute, to the database update list.

If module 230 determines that a source attribute has below a threshold amount of similarity to any target attribute, the source attribute is not present in the target schema, and needs to be added. Thus, module 230 adds the source attribute to the target schema. Another implementation of module 230 does not add the source attribute to the target schema during attribute comparison, but instead adds the source attribute to a schema update list. The schema update list holds updates to the target schema to be implemented when data from the source database is propagated to the target database.

Module 230 selects another source attribute from the source attribute list and repeats the comparison process. One implementation of module 230 repeats the comparison process until every source attribute in the source attribute list has been compared in a manner described herein.

Another implementation of module 230 implements a comparison process with two thresholds, one above the other. If module 230 determines that a source attribute has an amount similarity to a target attribute that is above the upper threshold, module 230 t compares formats of the two attributes. If the formats are not identical, module 230 adds a format conversion, when moving data from the source to the target attribute, to the database update list. If, however, the formats are identical, module 230 determines whether or not the source and target attributes are identical to each other. If the source and target attributes are not identical to each other, an attribute change will be needed, and module 230 adds an attribute conversion, when moving data from the source to the target attribute, to the database update list.

If module 230 determines that a source attribute has an amount of similarity below the lower threshold amount of similarity to any target attribute, the source attribute is not present in the target schema, and needs to be added. Thus, module 230 adds the source attribute to the target schema. Another implementation of module 230 does not add the source attribute to the target schema during attribute comparison, but instead adds the source attribute to the schema update list.

If, however, module 230 determines that a source attribute has an amount of similarity between the upper threshold and the lower threshold amount of similarity to a target attribute, module 230 asks a user to confirm whether the attributes should be treated as synonyms or not. If the user confirms that the attributes should be treated as synonyms, module 230 uses this data to update the synonym model. Updating the synonym model trains the synonym model to include a synonym relationship between the source attribute and the target attribute.

One implementation of module 230 uses different synonym models to determine synonyms in different areas of knowledge. For example, one synonym model might be used when processing databases storing pharmaceutical data, while another synonym model might be used when processing databases storing office building data. Implementing different synonym models for different areas of knowledge permits a subject matter expert to train a synonym model in his or her own area of expertise, and allows for adapting application 200 to a different area of knowledge simply by changing a synonym to one trained on the new area of knowledge.

One implementation of target database update module 240 obtains approval from a user before performing a target schema update or implementing any format or attribute conversions in the database update list. Another implementation of module 240 determines if there are any immutable objects in the database update list, and if so obtains approval from a user to implement the updates using a new attribute (which is added to the database update list). Another implementation of module 240 records any target schema updates and format or attribute conversions.

An implementation of module 240 using a schema update list updates the target schema according to the schema update list. Module 240 stores data from the source database in the target database, implementing any format or attribute conversions in the database update list that are also not in an immutable objects list during data storage. To obtain data from the source database and update the target schema and the target database, one implementation of module 240 uses database commands implemented using SQL statements. Another implementation of module 240 uses database commands implemented using statements in another database query language.

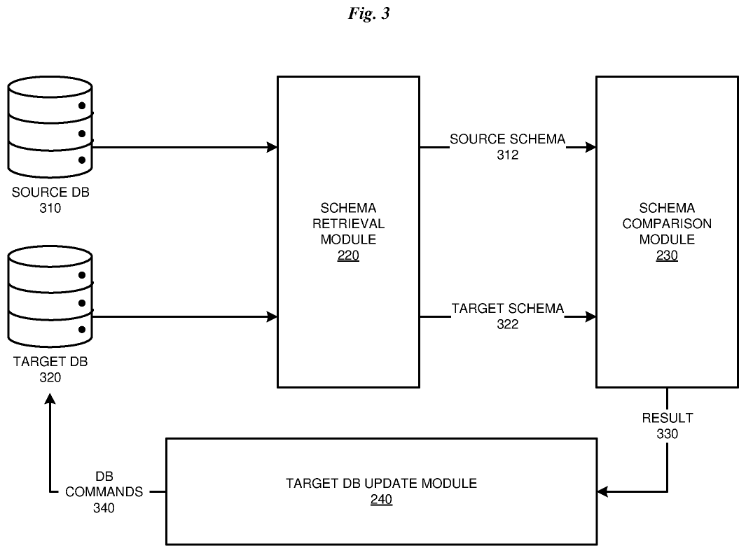

With reference to FIG. 3, this figure depicts an example of serverless schema propagation in accordance with an illustrative embodiment. Schema retrieval module 220, schema comparison module 230, and target database update module 240 are the same as schema retrieval module 220, schema comparison module 230, and target database update module 240 in FIG. 2.

As depicted, schema retrieval module 220 uses SQL statements or another database query language to extract source schema 312 from source database 310 and target schema 322 from target database 320. Schema comparison module 230 identifies, by comparing source schema 312 with target schema 322, result 330 including a mismatch between source schema 312 and target schema 322. Target database update module 240 uses result 330 to generate database commands 340, updating target database 320.

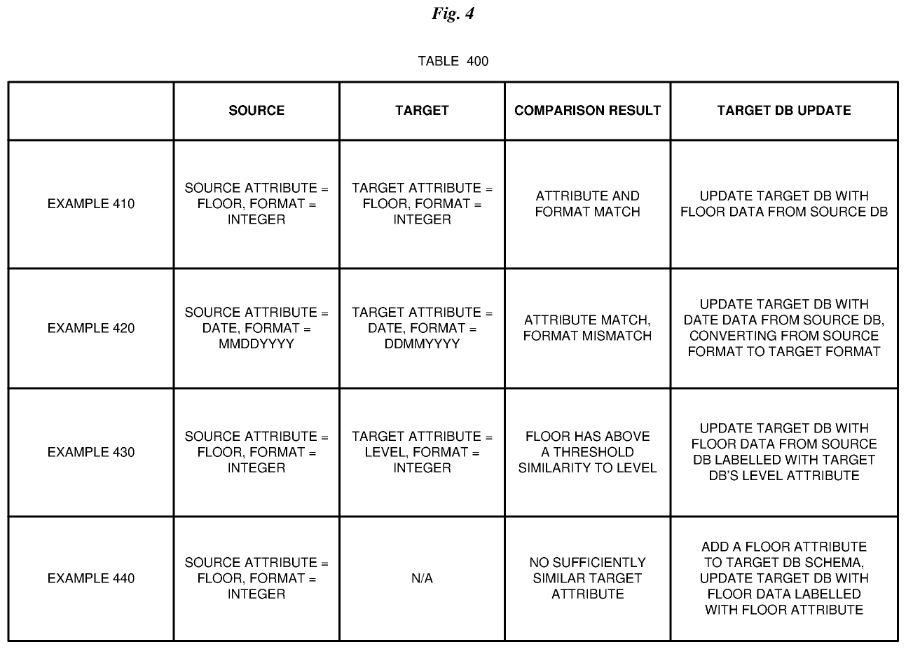

With reference to FIG. 4, this figure depicts examples of attribute comparison results and corresponding target database updates used in serverless schema propagation in accordance with an illustrative embodiment.

In table 400, example 410 depicts an example of source and target attributes, as well as their formats, being identical. As a result, no attribute or format change is needed, and data of the source attribute is stored in the target database and labelled with the target attribute.

Example 420 depicts an example of source and target attributes being identical, but their formats are not identical. As a result, a format change is needed, and data of the source attribute is stored in the target database, labelled with the target attribute and in a format specified by a format conversion rule.

Example 430 depicts an example of source and target attributes being non-identical, but with above a threshold similarity with each other. As a result, data of the source attribute is stored in the target database and labelled with the target attribute.

Example 440 depicts an example of no target attributes being sufficiently similar to a source attribute. As a result, the source attribute is added to the target schema.

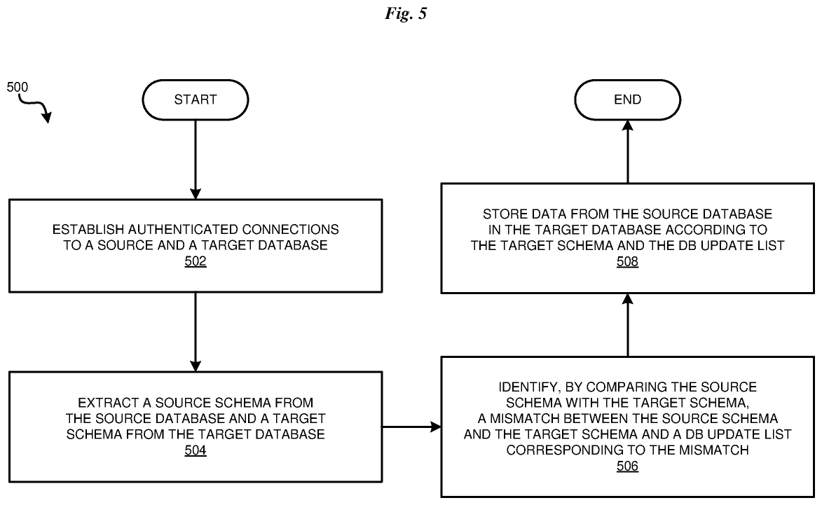

With reference to FIG. 5, this figure depicts a flowchart of an example process for serverless schema propagation in accordance with an illustrative embodiment. Process 500 can be implemented in application 200 in FIG. 2.

In block 502, the application establishes authenticated connections to a source and a target database. In block 504, the application extracts a source schema from the source database and a target schema from the target database. In block 506, the application identifies, by comparing the source schema with the target schema, a mismatch between the source schema and the target schema and a database update list corresponding to the mismatch. In block 508, the application stores data from the source database in the target database according to the target schema and the database update list. Then the application ends.

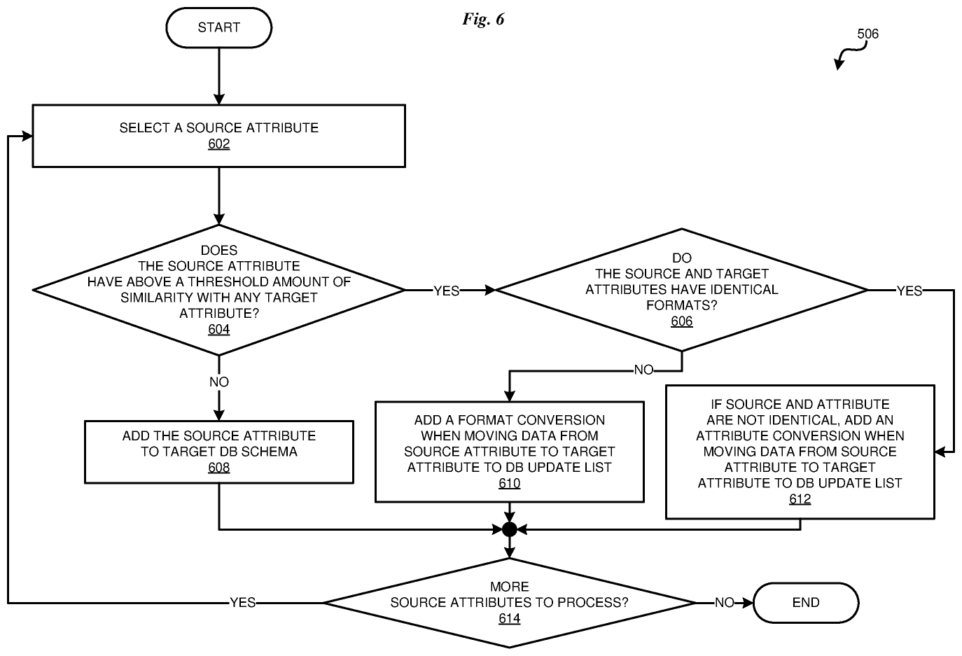

With reference to FIG. 6, this figure depicts a flowchart of an example process for serverless schema propagation in accordance with an illustrative embodiment. In particular, FIG. 6 depicts more detail of block 506 in FIG. 5.

In block 602, the application selects a source attribute. In block 604, the application determines whether the source attribute has above a threshold similarity with any target attribute. If not (“NO” path of block 604), in block 608 the application adds the source attribute to the target database schema. If yes (“YES” path of block 604), in block 606 the application determines whether the source and target attributes have identical formats. If not (“NO” path of block 606), in block 610 the application adds a format conversion when moving data from the source attribute to the target attribute to a database update list. If yes (“YES” path of block 606), in block 612 the application, if the source and target attributes are not identical, adds an attribute conversion when moving data from the source attribute to the target attribute to a database update list. After blocks 608, 610, and 612, in block 614 the application determines whether there are more source attributes to process. If yes (“YES” path of block 614), the application returns to block 602 to select another source attribute. Otherwise (“NO” path of block 614), the application ends.

Thus, a computer implemented method, system or apparatus, and computer program product are provided in the illustrative embodiments for serverless schema propagation and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method comprising:
establishing, at a first system, using an authentication parameter for a source database hosted on a source system, a first connection between the source database and the first system, wherein the source system and the first system are different from each other:
establishing, at the first system, using an authentication parameter for a target database hosted on a target system, a second connection between the target database and the first system, wherein the target system and the first system are different from each other:
extracting, using a first command sent via the first connection from the first system to the source system, a source schema from the source database;
extracting, using a second command sent via the second connection from the first system to the target system, a target schema from the target database;
identifying, by comparing the source schema with the target schema, a mismatch between the source schema and the target schema; and
storing, in the target database according to the target schema and the mismatch, data from the source database.

2. The computer-implemented method of claim 1, further comprising:
adding, responsive to determining that a source attribute specified by the source schema has below a threshold amount of similarity with any target attribute specified by the target schema, the source attribute to the target schema.

3. The computer-implemented method of claim 1, wherein identifying the mismatch comprises:
determining that a source attribute specified by the source schema has above a threshold amount of similarity with a target attribute specified by the target schema.

4. The computer-implemented method of claim 3, further comprising:
constructing, responsive to determining that a source format specified by the source attribute is not identical to a target format specified by the target attribute, a format conversion, the format conversion specifying a conversion from the source format to the target format;
adding, to a database update list, the format conversion; and
storing, in the target database in a format specified by the format conversion and labelled with the target attribute, data of the source attribute.

5. The computer-implemented method of claim 3, further comprising:
constructing, responsive to determining that a source format specified by the source attribute is identical to a target format specified by the target attribute and determining that the source attribute and the target attribute are not identical to each other, an attribute conversion, the attribute conversion specifying a conversion from the source attribute to the target attribute;
adding, to a database update list, the attribute conversion; and
storing, in the target database and labelled with the target attribute, data of the source attribute.

6. The computer-implemented method of claim 3, wherein determining that the source attribute has above the threshold amount of similarity with the target attribute is performed using a trained synonym model.

7. The computer-implemented method of claim 6, wherein the trained synonym model determines a cosine similarity between a source numerical representation of the source attribute and a target numerical representation of the target attribute.

8. The computer-implemented method of claim 6, further comprising:
updating, responsive to a user confirmation of similarity between the source attribute and the target attribute, the trained synonym model, the updating training the synonym model to include a synonym relationship between the source attribute and the target attribute.

9. A computer program product comprising one or more computer readable storage medium, and program instructions collectively stored on the one or more computer readable storage medium, the program instructions executable by a processor to cause the processor to perform operations comprising:
establishing, at a first system, using an authentication parameter for a source database hosted on a source system, a first connection between the source database and the first system, wherein the source system and the first system are different from each other:
establishing, at the first system, using an authentication parameter for a target database hosted on a target system, a second connection between the target database and the first system, wherein the target system and the first system are different from each other:
extracting, using a first command sent via the first connection from the first system to the source system, a source schema from the source database;
extracting, using a second command sent via the second connection from the first system to the target system, a target schema from the target database;
identifying, by comparing the source schema with the target schema, a mismatch between the source schema and the target schema; and
storing, in the target database according to the target schema and the mismatch, data from the source database.

10. The computer program product of claim 9, wherein the stored program instructions are stored in a computer readable storage device in a data processing system, and wherein the stored program instructions are transferred over a network from a remote data processing system.

11. The computer program product of claim 9, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

12. The computer program product of claim 9, further comprising:
adding, responsive to determining that a source attribute specified by the source schema has below a threshold amount of similarity with any target attribute specified by the target schema, the source attribute to the target schema.

13. The computer program product of claim 9, wherein identifying the mismatch comprises:
determining that a source attribute specified by the source schema has above a threshold amount of similarity with a target attribute specified by the target schema.

14. The computer program product of claim 13, further comprising:
constructing, responsive to determining that a source format specified by the source attribute is not identical to a target format specified by the target attribute, a format conversion, the format conversion specifying a conversion from the source format to the target format;
adding, to a database update list, the format conversion; and
storing, in the target database in a format specified by the format conversion and labelled with the target attribute, data of the source attribute.

15. The computer program product of claim 13, further comprising:
constructing, responsive to determining that a source format specified by the source attribute is identical to a target format specified by the target attribute and determining that the source attribute and the target attribute are not identical to each other, an attribute conversion, the attribute conversion specifying a conversion from the source attribute to the target attribute;
adding, to a database update list, the attribute conversion; and
storing, in the target database and labelled with the target attribute, data of the source attribute.

16. The computer program product of claim 13, wherein determining that the source attribute has above the threshold amount of similarity with the target attribute is performed using a trained synonym model.

17. The computer program product of claim 16, wherein the trained synonym model determines a cosine similarity between a source numerical representation of the source attribute and a target numerical representation of the target attribute.

18. The computer program product of claim 16, further comprising:
updating, responsive to a user confirmation of similarity between the source attribute and the target attribute, the trained synonym model, the updating training the synonym model to include a synonym relationship between the source attribute and the target attribute.

19. A computer system comprising a processor and one or more computer readable storage media, and program instructions collectively stored on the one or more computer readable storage media, the program instructions executable by the processor to cause the processor to perform operations comprising:
establishing, at a first system, using an authentication parameter for a source database hosted on a source system, a first connection between the source database and the first system, wherein the source system and the first system are different from each other:
establishing, at the first system, using an authentication parameter for a target database hosted on a target system, a second connection between the target database and the first system, wherein the target system and the first system are different from each other:
extracting, using a first command sent via the first connection from the first system to the source system, a source schema from the source database;
extracting, using a second command sent via the second connection from the first system to the target system, a target schema from the target database;
identifying, by comparing the source schema with the target schema, a mismatch between the source schema and the target schema; and
storing, in the target database according to the target schema and the mismatch, data from the source database.

20. The computer system of claim 19, further comprising:
adding, responsive to determining that a source attribute specified by the source schema has below a threshold amount of similarity with any target attribute specified by the target schema, the source attribute to the target schema.
